(19) United States
(12) Patent Application Publication
(10) Pub. No.: US 2006/0148543 A1
(43) Pub. Date: Jul. 6, 2006

(54) FLIPPER PHONE CONFIGURATION

(75) Inventor: Charles Hunt, Wake Forest, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIONS AB, Lund (SE)

(21) Appl. No.: 10/905,373

(22) Filed: Dec. 30, 2004

(51) Int. Cl. H04M 1/00; H04B 1/38

(52) U.S. Cl. 455/575.4; 455/575.1

(57) ABSTRACT

A mobile terminal for use in a wireless communication system comprises a housing including a first portion and a second portion. The first portion of the housing has an opening, an inner surface and an opposed outer surface. A module has an inner major surface and an outer major surface. The module is movably disposed in the opening of the first portion of the housing for movement relative to the first portion of the housing between a first position, where the inner major surface of the module is substantially coincident with the inner surface of the first portion of the housing, and a second position, where the inner major surface of the module is substantially coincident with the outer surface of the first portion of the housing.

### BACKGROUND

This invention relates generally to a mobile communication device, and more particularly to a mobile terminal for use in a wireless communication system wherein the mobile terminal includes a display.

A mobile terminal is used for sending and receiving information in a wireless communication system, such as a mobile telephone in a cellular telephone system. A mobile telephone typically includes a display and input mechanisms, such as keypads, buttons, and the like, which are used to control the mobile telephone. The display is used for viewing information and the input mechanisms typically provide for data entry, as well as control of any multi-media interface including the display.

With the growing popularity of the internet, mobile telephones are being used as receivers for not only voice data, but also various forms of visual data viewable on the display, such as e-mail, faxes or other forms of processed documents, pictures, videos or web pages. Mobile telephones can also function as a gaming device. Further, some mobile telephones now also include a camera function for capturing images and satisfying the rising demand for video or image-based communication. Capturing images is typically accomplished by manually actuating the camera function via a shutter button or a specified sequence of key strokes.

As the various functions of a mobile telephone increase, so does the need for varying types of input mechanisms for each function. At the same time, finding ways to achieve additional space savings for mobile telephones is desirable to vendors and consumers alike. As mobile telephones become smaller, less area is available for the input mechanisms. For ergonomic reasons, there is a limit below which it is undesirable to decrease the size. For example, size limitations lead to difficulty in viewing the display while communicating over the mobile telephone or providing user input. Enlargement of the mobile telephone is not a solution, since increased size of the mobile telephone defeats the purpose of a compact, portable communication device.

The goal of maintaining the compactness of a mobile telephone is advanced by a “flip phone”, wherein the housing of the mobile telephone includes two body portions pivotally joined at one end such that one body portion serves as a “flip” cover. In this arrangement, the body portions of the housing are moveable between an open position and a closed position. In the open position, a display and keypad are visible and accessible. In the closed position, the display and keypad are substantially concealed, which can be a disadvantage in using some of the functions of the mobile telephone. Another type of mobile telephone, sometimes referred to as a “jackknife phone”, has a housing including two body portions which pivot about an axis perpendicular to the longitudinal plane of the housing. This configuration allows for the display to always be on the outside of the mobile telephone. However, the mechanical and electrical connections between the body portions is complex. Still another type of mobile telephone is sometimes referred to as a “slider”, wherein the body portions of the housing slide longitudinally relative to one another between an open position and a closed position. This configuration also allows for the display to always be on the outside of the mobile telephone. Unfortunately, this affords little protection for the display.

For the foregoing reasons, there is a need for a mobile terminal for use in a wireless communication system which is adapted to efficiently accommodate multiple functions while maintaining compactness and portability. The new mobile terminal should allow the display to be selectively visible in a plurality of positions of the mobile terminal.

### SUMMARY

According to the present invention, a mobile terminal is provided for use in a wireless communication system. The mobile terminal comprises a housing including a first portion and a second portion. The first portion of the housing has an opening, an inner surface and an opposed outer surface. A module has an inner major surface and an outer major surface. The module is movably disposed in the opening of the first portion of the housing for movement relative to the first portion of the housing between a first position, where the inner major surface of the module is substantially coincident with the inner surface of the first portion of the housing, and a second position, where the inner major surface of the module is substantially coincident with the outer surface of the first portion of the housing.

### BRIEF DESCRIPTION OF THE DRAWINGS

For a more complete understanding of the present invention, reference should now be had to the embodiments shown in the accompanying drawings and described below. In the drawings:

FIG. 1 is a front perspective view of an embodiment of a mobile terminal according to the present invention with the mobile terminal in a closed position.

FIG. 2 is a front perspective view of the mobile terminal shown in FIG. 1 with the mobile terminal in an open position.

FIG. 3 is a rear perspective view of the mobile terminal as shown in FIG. 2.

FIG. 4 is a perspective view of the mobile terminal as shown in FIG. 2 with a display between the position shown in FIG. 2 and a second position.

FIG. 5 is a rear perspective view of the mobile terminal as shown in FIG. 3 with the display in the second position.

FIG. 6 is a front elevation view of the mobile terminal shown in FIG. 4 with the display in the second position and the mobile terminal in the closed position.

### DESCRIPTION

Certain terminology is used herein for convenience only and is not to be taken as a limitation on the invention. For example, words such as “upper,” “lower,” “left,” “right,” “horizontal,” “vertical,” “upward,” and “downward” merely describe the configuration shown in the FIGs. Indeed, the components may be oriented in any direction and the terminology, therefore, should be understood as encompassing such variations unless specified otherwise.

As used herein, the term “camera” is used to mean an imaging device usually provided with an optical lens, or system of lenses, through which light from an object passes and forms an image, usually on a light-sensitive medium. The term “camera” includes an imaging device wherein an image is captured as a still picture, or a series of images are captured as in a movie camera or video camera.

As used herein, the term “keypad” is used to mean any type of input device including a touch sensitive area or areas, which may include predefined key positions or a gesture area. Further, the term “keypad” is not intended to be limited to a keypad based on contacting switch technology. Rather, “keypad” as contemplated by this disclosure is intended to refer to any type of input technology that might be referred to as such, including a non-contacting type more typically referred to as a “touchpad” in which the proximity of conductive bodies is sensed.

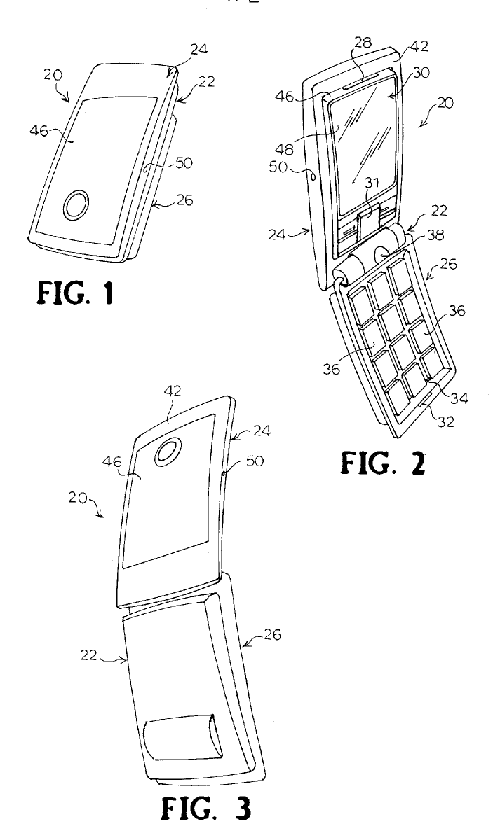

Referring now to the drawings, wherein like reference numerals designate corresponding or similar elements throughout the several views, a mobile terminal according to the present invention is shown in FIGS. 1-3 and generally designated at 20. The mobile terminal 20 is adapted for use in a wireless communication network and, in the embodiment shown in the FIGs., the mobile terminal 20 is a cellular telephone, which may be conventional except as otherwise provided in this description. The mobile terminal 20 comprises a housing 22, which may be of any desired size and shape; however, as described above, the trend is toward a smaller mobile terminal 20. The housing 22 contains electronic components that are operable to transmit and receive telecommunication signals, as is known in the art, and for operating other functions of the mobile terminal 20.

The housing 22 includes an upper portion 24 and a lower portion 26. The upper portion 24 of the housing 22 includes an ear piece 28, or speaker, for emitting sound and a display 30 for displaying alphanumeric text and graphics and other images. The display 30 can be monochrome or color. Menu keys 31, including soft keys or function keys, may be provided on the upper portion 24 of the housing 22 for receiving tactile input. The menu keys 31 may be used to interact with the image on the display 30. The lower portion 24 of the housing 22 includes a microphone 32 for inputting sound and a keypad apparatus 34 including alphanumeric and function keys 36 that can receive tactile input. The upper portion 24 and the lower portion 26 of the housing 22 are electrically connected so that the user can use the keypad 34 for tactile input to enter data, make telephone calls, interact with an image on the display 30, or otherwise control operation of the mobile terminal 20. Various other controls may also be provided on the housing 22, such as special purpose keys (not shown) that control one or more functional aspects of the mobile terminal 20. Because there are many types of mobile terminal housings 22 and associated components that are well known in the art and that may be utilized to practice the present invention, a more detailed description of these components is not required. It is understood that the present invention is not directed to any particular style of housing.

The upper housing portion 24 may also provide a camera function for the mobile terminal 20. In this embodiment, the outer surface of the upper housing portion 24 (FIG. 3) defines an opening for a lens 38 of the camera. A shutter release button 40 is provided for actuating the camera function. It is understood that the orientation of the lens 38 shown in FIG. 3 is illustrative only and that the lens 38 and shutter release button 40 can be positioned in many different locations. In standard operation of the camera integrated into the mobile terminal 20, the user typically grips the mobile terminal 20 in one hand and points the lens 38 at the target. The user uses the display 30 as a viewfinder while aiming the lens 38 at the target for coordinating the shot by viewing the display 30. The user's thumb (or another finger) can rest on the shutter button 40 while the shot is lined up. When the user is satisfied with the shot as indicated in the display 30, she can depress the shutter button 40 and capture an image of the target.

A main processor and a memory within the mobile terminal control the overall operation of the mobile terminal 20 and are together referred to herein as a “controller”, as is known in the art. Electrical and programmatic functions that are necessary to enable full use of the mobile terminal 20 are implemented through the controller. The controller, along with any microcode or other software instructions, comprise means for providing input to the mobile terminal 20. Certain embodiments of the present invention may be carried out by hardwired circuitry rather than by executing software, or by a combination of hardwired circuitry with software. Hence, it will be recognized that the present invention is not limited to any specific combination of hardware circuitry and software, nor to any particular source for software instructions.

The upper portion 24 and the lower portion 26 of the housing 22 are pivotally joined at one end such that the housing may function as a “flip phone”, as is conventional. In this arrangement, the upper portion 24 and the lower portion 26 of the housing 22 are moveable between a closed position, shown in FIG. 1, and an open position, shown in FIGS. 2 and 3. In the closed position, the inner surface of the upper portion 24 of the housing 22 is in close and complementary registration with the inner surface of the lower portion 26 of the housing 22 such that the display 30, menu keys 31 and the keypad 34 are substantially concealed. The outer surface of the upper portion 24 and the lower portion 26 of the housing 22 form the exterior surfaces of the mobile terminal 20 in the closed position. In the open position, the display 30, menu keys 31 and keypad 34 on the inner surfaces of the upper portion 24 and the lower portion 26 of the housing 22, respectively, are visible and accessible to a user. A switch or sensor may be provided within the housing 22 for sensing the position of the respective housing portions 24, 26. The switch or sensor enables the mobile terminal 20 to, for example, answer individual calls upon opening the mobile terminal 20, as is known in the art.

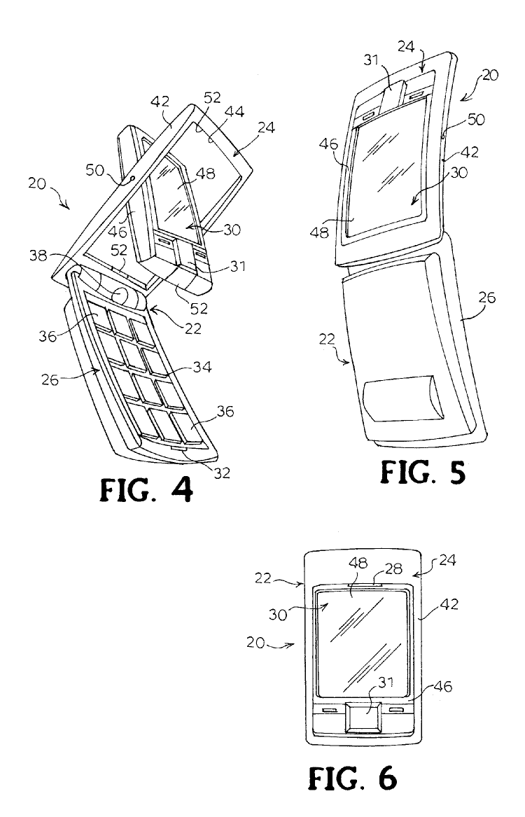

Referring to FIGS. 2 and 4, according to the present invention, the upper portion 24 of the housing 22 comprises a frame 42 having a central opening 44 and a module 46 disposed in the frame 42. In the embodiment shown in the FIGs., the module 46 comprises the display 30, including an LCD panel 48 having a display surface exposed through the opening 44, and the menu keys 31. The LCD panel 48 may be any of a number of commonly used built-in displays for cellular telephones or other mobile terminals.

The module 46 is pivotally mounted to the frame 42 at opposed pivoting connection points 50 at the longitudinal midpoint of the module 46 such that the module 46 is rotatable relative to the frame 42 about the connection points 50 through a range of up to at least about 180°. Accordingly, the module 46 is rotatable between a first position, shown in FIG. 2, and a second position shown in FIG. 5 which is reached following a 180° rotation of the module 46 from the FIG. 2 position. A keying mechanism (not shown) may be provided to limit relative rotation of the module 46 to about 180°. Alternatively, the module 46 may be made to rotate a full 360°.

Electrical contacts 52 may be provided on the frame 42 and the edge of the module 46. The contacts 52 engage in the first and second positions of the module 46 for electrically connecting the module 46 to the electronic components in the housing 22. Thus, when the module 46 is moved between the first and second positions, the ability to send and receive signals is automatically reinitiated when the module 46 reaches the new position. Electrical connection of the module 46 to the electronic components in the housing 22 could also be accomplished through the connection points 50. Alternatively, other means may be provided for electrically connecting the module 46 to the electronic components in the housing 22. For example, a switch, a relay or the like (not shown) could be operatively associated with the frame 42 and the module 46. A sensor could also be used to enable the determination of the relative position of the module 46 and the frame 42, eliminating the need for the separate switch. Signals may also be sent between the upper portion 24 and the lower portion 26 of the housing 22 via a Bluetooth or WLAN component in each portion of the housing 22. The antennas for the respective housing portions would preferably be located proximate to each other to allow for near-field coupling.

In the first position of the module 46 (FIG. 2), the display 30 is substantially coincident with the inner surface of the frame 42 and is visible when the mobile terminal 20 is in the open position, as described above. In the second position of the module 46 (FIG. 5), after having been rotated 180° from the first position, the display 30 is substantially coincident with the outer surface of the frame 42. In the closed position of the mobile terminal 20 with the module 46 in the second position, shown in FIG. 6, the outer surface of the module 46 is in close and complementary registration with the inner surface of the lower housing portion 26 such that the keypad 34 is substantially concealed while the display 30 is revealed. Accordingly, the display 30 is visible when the mobile terminal 20 is in the closed position. Thus, a user can select the preferred arrangement of the mobile terminal 20 and position the display 30 in the upper portion 24 of the housing 22 by rotating the module 46 relative to the frame 42 for exposing the display 30 on the preferred side of the upper portion 24 allowing the display 30 to be visible or concealed when the mobile terminal 20 is in the closed position.

While the present invention is described herein in the context of a mobile terminal in the form of a mobile cellular telephone, it should be understood that the mobile terminal of the present invention is not so limited and may find utility in other electronics devices and applications. For example, the term “mobile telephone” as used herein may include a cellular radiotelephone with or without a multi-line display; landline and cordless telephones; a Personal Communications System (PCS) terminal that may combine a cellular telephone with data processing, facsimile and data communications capabilities; internet/intranet access devices; organizers; a Personal Digital Assistant (PDA) that can include a radiotelephone, pager, internet/intranet access, Web browser, organizer, calendar and/or a global positioning system (GPS) receiver; wristwatch keypad devices; and a conventional laptop and/or palmtop receiver or other computer system that includes a display. Mobile telephones may also be referred to as “pervasive computing” devices. In one embodiment of the present invention, the invention may be implemented on a computer system having a memory circuit for storage of data, a display which acts to generate images, and a control circuit that is configured to control the flow of data between the memory and receiver.

Although the present invention has been shown and described in considerable detail with respect to only a few exemplary embodiments thereof, it should be understood by those skilled in the art that I do not intend to limit the invention to the embodiments since various modifications, omissions and additions may be made to the disclosed embodiments without materially departing from the novel teachings and advantages of the invention, particularly in light of the foregoing teachings. For example, the present invention is suitable for use in a number of portable and non-portable electronics devices and applications. Accordingly, we intend to cover all such modifications, omission, additions and equivalents as may be included within the spirit and scope of the invention as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A mobile terminal for use in a wireless communication system, the mobile terminal comprising:
a housing including a first portion and a second portion, the first portion of the housing having an opening, an inner surface and an opposed outer surface; and
a module having an inner major surface and an outer major surface, the module movably disposed in the opening of the first portion of the housing for movement relative to the first portion of the housing between a first position where the inner major surface of the module is substantially coincident with the inner surface of the first portion of the housing and a second position where the inner major surface of the module is substantially coincident with the outer surface of the first portion of the housing.

2. A mobile terminal as recited in claim 1, wherein the second portion of the housing has an inner major surface and an outer major surface, and wherein the second portion of the housing is movably mounted to the first portion of the housing for movement between an open position of the housing where the inner surface of the first portion of the housing and the inner major surface of the second portion of the housing are visible and accessible and a closed position of the housing where the inner major surface of the second portion of the housing is opposite the inner surface of the first portion of the housing, the second portion of the housing being sized for at least partially concealing the inner major surface of the module when the module is in the first position and such that the inner major surface of the module is exposed and accessible to the user when the module is in the second position and the housing is in the closed position.

3. A mobile terminal as recited in claim 1, further comprising a hinge for movably connecting the first portion of the housing and the second portion of the housing adjacent the ends of the first portion of the housing and the second portion of the housing, the hinge providing an axis of relative movement of the first portion of the housing and the second portion of the housing.

4. A mobile terminal as recited in claim 1, wherein the inner major surface of the module comprises a display.

5. A mobile terminal as recited in claim 4, wherein the inner major surface of the module further comprises means for providing user input to the mobile terminal.

6. A mobile terminal as recited in claim 5, wherein the user input providing means comprises a keypad apparatus electrically connected to the display so that tactile input to the keypad is received by the display.

7. A mobile terminal as recited in claim 1, wherein the housing further comprises means for providing user input to the mobile terminal.

8. A mobile terminal as recited in claim 7, wherein the user input providing means is associated with the inner major surface of the second portion of the housing.

9. A mobile terminal as recited in claim 7, wherein the user input providing means comprises a keypad apparatus electrically connected to the module so that tactile input to the keypad is received by the module.

10. A mobile terminal as recited in claim 1, wherein the housing encloses electronic components operable to transmit and receive telecommunication signals.

11. A mobile terminal as recited in claim 10, wherein the module is electrically connected to the electronic components in the housing.

12. A mobile terminal as recited in claim 1, wherein the module is mounted to the first portion of the housing for pivoting movement on an axis.

13. A mobile terminal as recited in claim 12, wherein the axis of pivoting movement is along the longitudinal midpoint of the module.

14. A mobile terminal as recited in claim 12, wherein the module is adapted to rotate at least about 180 degrees relative to the first portion of the housing.

15. A mobile terminal as recited in claim 1, wherein the mobile terminal is a cellular telephone.

16. A mobile terminal as recited in claim 1, further comprising an imaging device including a lens, the imaging device disposed within the housing for capturing an image through the lens.
